(19) United States
(12) Patent Application Publication
(10) Pub. No.: US 2015/0187288 A1
(43) Pub. Date: Jul. 2, 2015

(54) White Tracking Adjustment Method, Manufacturing Method of Liquid Crystal Display and Liquid Crystal Display

(71) Applicant: Shenzhen China Star Optoelectronics Technology Co., Ltd., Shenzhen, Guangdong (CN)

(72) Inventors: Yu-yeh Chen, Shenzhen (CN); Yin-hung Chen, Shenzhen (CN); Dongsheng Guo, Shenzhen (CN)

(21) Appl. No.: 14/233,154

(22) PCT Filed: Jan. 2, 2014
(86) PCT No.: PCT/CN2014/070044

§ 371 Date: Jan. 15, 2014

(30) Foreign Application Priority Data
Dec. 26, 2013 (CN) 201310733243.1

(51) Int. Cl. G09G 3/36

(52) U.S. Cl. CPC G09G 3/3607

(57) ABSTRACT

The present invention discloses a white tracking adjustment method, which is used to adjust the color shift of liquid crystal display, it comprises: dividing a display panel of a liquid crystal display into a plurality of regions according to the difference of the distance of the trace kept away from a source driving IC; respectively adjusting the white tracking of the plurality regions referring to the different white tracking reference tables. The present invention also provides a manufacturing method of a liquid crystal display and a liquid crystal display obtained through the method, adjusting the liquid crystal display panel through adopting the white tracking adjustment method as described above. The present invention adopts the dividing region adjustment approach, solving the color shift caused by the difference of the trace distance on each part of the panel during adopting the COF trace method in the display panel of the liquid crystal display.

### BACKGROUND OF THE INVENTION

1. Field of the Invention

The present invention relates to the liquid crystal display technical field, and in particular to a color shift adjustment method of a liquid crystal display panel in a liquid crystal display, the present invention also relates to a manufacturing method of a liquid crystal display and a liquid crystal display obtained according to the manufacturing method.

2. The Related Arts

Liquid Crystal Display, LCD, is flat and thin display device, it is composed by a number of color or monochrome pixels, which is placed in front of the light source or reflecting surface. The power consumption of the liquid crystal display is very low, it has the characteristics of high-quality, small size and light weight, therefore, it is favored by everyone, becoming the mainstream of display. The current liquid crystal display is mainly Thin Film Transistor (TFT) liquid crystal display, the liquid crystal display panel is the main component of the liquid crystal display. The liquid crystal display panel is generally comprises a relatively disposed color filter substrate, a TFT array substrate and a liquid crystal layer between two substrates. Along with the development of the flat panel display technology, the screen quality demanded by people becomes higher, which comprises: brightness, color, resolution, viewing angle, refresh rate, etc.

A schematic diagram of an existing liquid crystal display panel as shown in FIG. 1, there are a plurality of pixel units 101 distributed in array in display panel 1, each of the pixel unit 101 corresponds to one of the red (R), green (G), and blue (B) colors, and arranging in the order R-G-B; there are a plurality scanning lines and data lines Line-1˜Line-2n provided between the rank of pixel unit 101 (as FIG. 1, Line-1 and Line-2n represent the data of two ends of the display panel, Line-n represents the data line of the center of display panel). The scanning line is connected to the gate driving IC3, the gate driving IC3 provides the scanning signal to the pixel unit 101 array, the data line is connected to the gate driving IC2, the gate driving IC2 provides the data signal to the pixel unit 101 array. In the trace way of using COF (Chip on Film), in the trace region 4 which the data line is connected with the source driving IC2, the trace distance of the source driving IC2 connected to the data line Line-n in the center of the display panel is more different with connected to the data lines Line-1 and Line-2n of two ends of the display panel, the impedance difference is also great, it leads to the delay of data signal output from the source driving IC2 to the display panel. FIG. 2 illustrates the data signal waveform diagram of the data lines Line-1, Line-n and Line-2n as example, wherein, the signals of Line-1 and Line-2n exist delay related to the signal of Line-n, since the delay of data signals, the display panel easily exists the color shift issue when it displays several screens. A schematic diagram of charge state of the data signal as shown in FIG. 3, to display pure green screen for example, when it displays solid color screen, since the delay of data signal, it may be mistakenly charged a little blue pixels. At this time, the screen on display panel will show normal and biased yellow on both sides of the region, but in the middle region is normal and biased green, there exists color shift.

This color shift phenomenon on both sides can be reduced through the adjustment of the optical WT (White Tracking). The current adjusting method is that the whole panels refer to a white tracking reference table, through adjusting the white tracking code in the white tracking reference table, it can adjust the red pixel brightness corresponded to the 0 gray scale, making the red pixel which is under the darkest state have a certain brightness. A schematic diagram of the data signal charging state as shown in FIG. 4, there are several red brightness turned on under the pure green screen, in order to offset the tendency of measuring bluish; although this method can reduce the color shift on both side regions of the display panel, it will make the displayed screen in the middle region of the display panel be normal and biased yellow.

### SUMMARY OF THE INVENTION

In view of the lack of prior art, the purpose in the present invention is to provide a white tracking adjustment method, solving the color shift caused by the difference of the trace distance on each part of the panel during adopting the COF trace method in the display panel of the liquid crystal display.

In order to achieve the above purpose, the present invention adopts the following technical solution:

A white tracking adjustment method, which is used to adjust the color shift of a liquid crystal display, it comprises:

dividing a display panel of a liquid crystal display into a plurality of regions according to the difference of the distance of the trace kept away from a source driving IC;

respectively adjusting the white tracking of the plurality regions referring to the different white tracking reference tables.

Wherein, in view of the region which the trace is far from the source driving IC, through changing the white tracking code in the white tracking reference table to adjust the white tracking, in order to offset the color shift resulted from the data signal delay caused by the difference of the trace distance.

Wherein, for each part of the source driving IC connected to the liquid crystal display panel, dividing the liquid display panel of this part into 3-7 regions.

Wherein, for each part of the source driving IC connected to the liquid crystal display panel, dividing the liquid display panel of this part into 3 regions.

Otherwise, the present invention provides a manufacturing method of a liquid crystal display, which comprises:

adjusting the white tracking of the liquid crystal display panel; wherein, the steps of the white tracking adjustment comprises:

dividing a display panel of a liquid crystal display into a plurality of regions according to the difference of the distance of the trace kept away from a source driving IC;

respectively adjusting the white tracking of the plurality regions referring to the different white tracking reference tables.

Wherein, in view of the region which the trace is far from the source driving IC, through changing the white tracking code in the white tracking reference table to adjust the white tracking, in order to offset the color shift resulted from the data signal delay caused by the difference of the trace distance.

Wherein, for each part of the source driving IC connected to the liquid crystal display panel, dividing the liquid display panel of this part into 3-7 regions.

Wherein, for each part of the source driving IC connected to the liquid crystal display panel, dividing the liquid display panel of this part into 3 regions.

The present invention also provides a liquid crystal display, which comprises a liquid crystal display panel, wherein, the liquid crystal adopts the white tracking adjustment method as described above.

Relating to the prior art, the white tracking adjustment method provided by the present invention adopts the approach of dividing region adjustment, solving the color shift caused by the difference of the trace distance on each part of the panel during adopting the COF trace method in the display panel of the liquid crystal display.

### BRIEF DESCRIPTION OF THE DRAWINGS

FIG. 1 is a schematic diagram of an existing liquid crystal display panel.

FIG. 2 is to illustrate a waveform of the source driving IC transmitting the data signal to the data line as example.

FIG. 3 is a schematic diagram of charge state of the data signal existing delay in the available display panel.

FIG. 4 is a schematic diagram of charge state of the data signal after adjusting the white tracking.

FIG. 5 is a step flow chart of the white tracking adjustment method provided by an embodiment in the present invention.

FIG. 6 is a schematic diagram of dividing the region of liquid crystal display panel in an embodiment in the present invention.

FIG. 7 is a schematic diagram of charge state of the data signal after adjusting the white tracking in an embodiment in the present invention.

### DETAILED DESCRIPTION OF THE PREFERRED EMBODIMENTS

As described above, in order to solve the issue in the prior art, the present invention provides a white tracking adjustment method, the step flow chart as shown in FIG. 5, which comprises:

S101. Dividing a display panel of a liquid crystal display into a plurality of regions according to the difference of the distance of the trace kept away from a source driving IC;

S102. Respectively adjusting the white tracking of the plurality regions referring to the different white tracking reference tables.

Through dividing the region of liquid crystal display panel, in view of the region which the trace is far from the source driving IC, through changing the white tracking code in the white tracking reference table to adjust the white tracking, in order to offset the color shift resulted from the data signal delay caused by the difference of the trace distance.

In several more preferable embodiments, for each part of the source driving IC connected to the liquid crystal display panel, dividing the liquid display panel of this part into 3-7 regions.

The following will use the specific embodiment with the drawings to further describe the present invention. The present embodiment is described by which the whole liquid crystal display panel only adopts a source driving IC as an exemplary embodiment, furthermore, in the present embodiment, dividing the whole liquid crystal display panel into 3 regions to specifically describe.

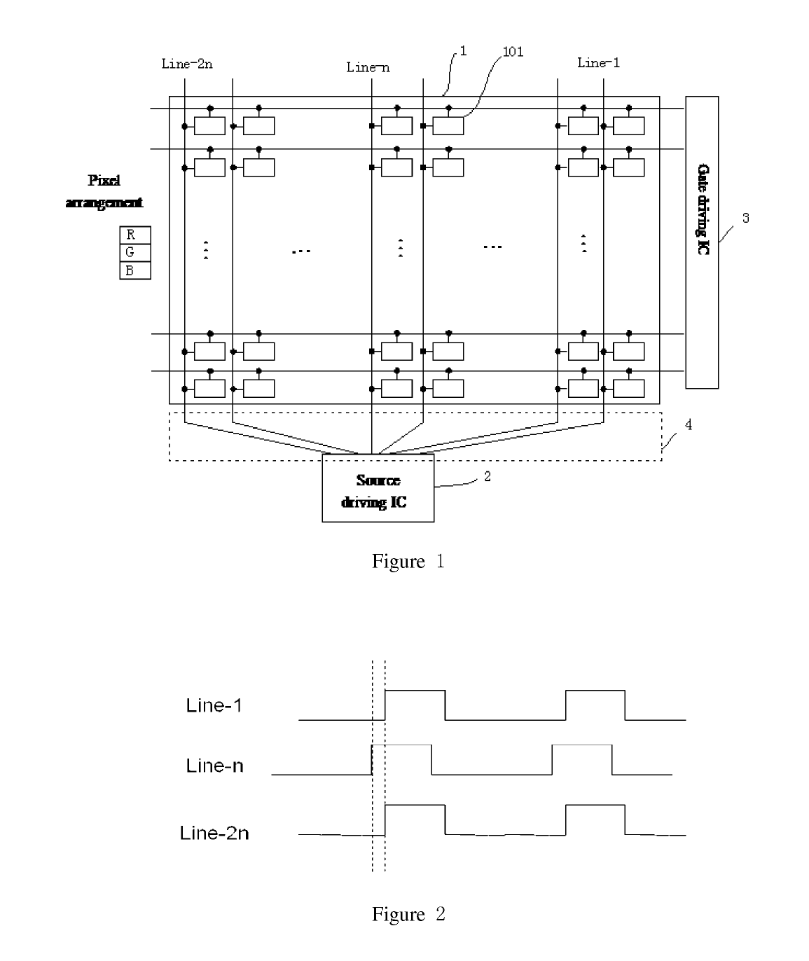

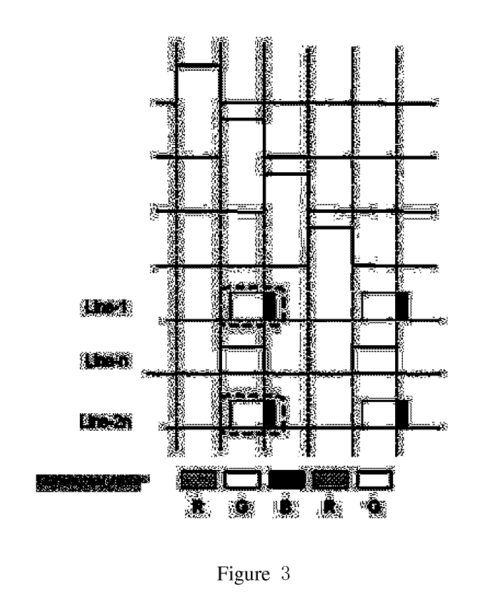

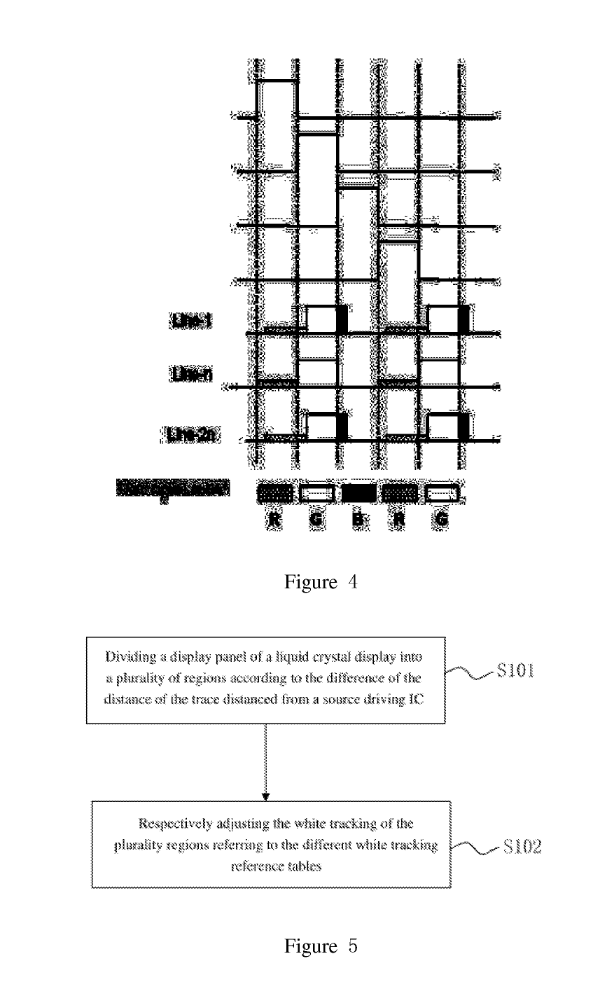

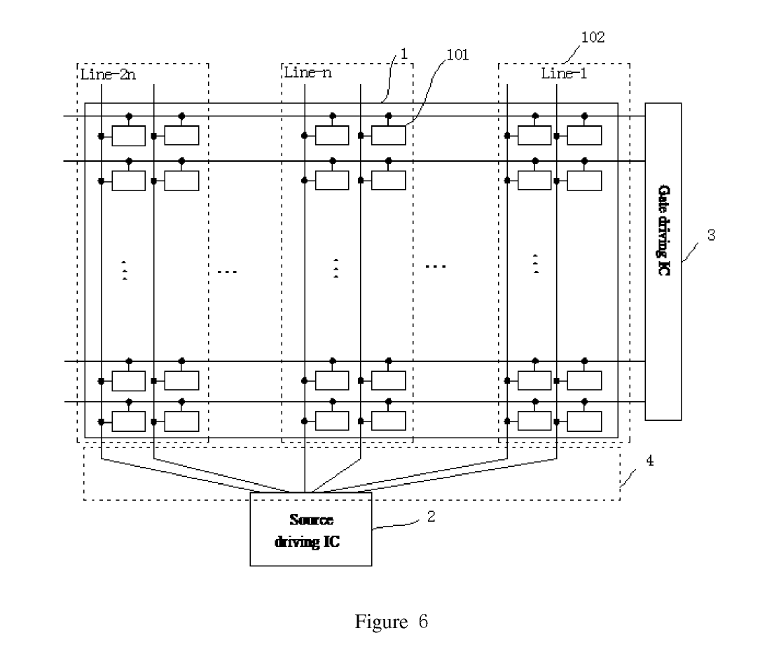

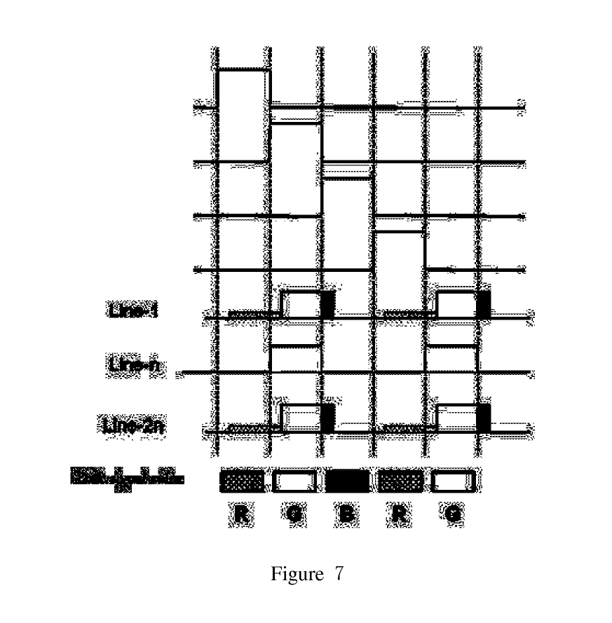

Referring to FIG. 6, there are a plurality of pixel units 101 distributed in array in display panel 1, each of the pixel unit 101 corresponds to one of the red (R), green (G), and blue (B) colors, and arranging in the order R-G-B; there are a plurality scanning lines and data lines Line-1˜Line-2n provided between the rank of pixel unit 101 (as FIG. 1, Line-1 and Line-2n represent the data of two ends of the display panel, Line-n represents the data line of the center of display panel). The scanning line is connected to the gate driving IC3, the gate driving IC3 provides the scanning signal to the pixel unit 101 array, the data line is connected to the gate driving IC2, the gate driving IC2 provides the data signal to the pixel unit 101 array. In the trace way of using COF (Chip on Film), in the trace region 4 which the data line is connected with the source driving IC2, the trace distance of the source driving IC2 connected to the data line Line-n in the center of the display panel is more different with connected to the data lines Line-1 and Line-2n of two ends of the display panel. Therefore, referring to the step flow chart in FIG. 5, at the first, dividing the region of the whole liquid crystal display panel, dividing a display panel of a liquid crystal display into 3 regions 102 according to the difference of the distance of the trace kept away from a source driving 102, which are respectively the regions near two ends and the middle region, and then respectively adjusting the white tracking of this 3 regions referring to the different white tracking reference tables. The present embodiment also takes a pure green screen for example, for the regions on the two ends, since the traces of data connection lines are longer, there are a delay during the data signal transmission, it can adjust the red brightness corresponded to the 0 gray scale, making the red pixel which is under the darkest state have a certain brightness, there are several red brightness turned on under the pure green screen, in order to offset the tendency of measuring bluish; but the middle region doesn't need to adjust the red brightness corresponded to the 0 gray scale. The schematic diagram of charge state of the data signal after adjusting the white tracking according to the above way as shown in FIG. 7, through this white tracking adjustment method, it can effectively improve the color shift issue of two ends of the display panel, at the same time, the picture quality in the middle region of the display panel will not be affected.

It needs to note that, several liquid crystal display panel may adopt a plurality of source driving IC, at this time, each part connected with the source driving IC can be adjusted by dividing it into a plurality of regions. As an exemplary description, for example, the whole liquid crystal display panel totally connects to two source driving IC, and each part connected with the source driving IC is divided into 3 different regions to adjust, therefore, the entire liquid crystal display panel is divided into 6 regions to respectively adjust the white tracking.

The present embodiment also provides a manufacturing method of liquid crystal display, which comprises the steps:

assembling a liquid crystal display panel;

adjusting the white tracking of the liquid crystal display panel; wherein, the steps of white tracking adjustment adopts the method as described above.

The present embodiment also provides a liquid crystal display, which comprises a liquid crystal display panel, the liquid crystal display panel comprises a relatively disposed color filter substrate, a TFT array substrate and a liquid crystal layer between two substrates, the TFT array substrate distributes in array the pixel unit, each pixel unit corresponds to one of first, second and third colors (red, green and blue); wherein, the liquid crystal display panel adopts the white tracking adjustment method as described above.

In summary, the white tracking adjustment method provided by the present invention adopts the dividing region adjustment approach, solving the color shift caused by the difference of the trace distance on each part of the panel during adopting the COF trace method in the display panel of the liquid crystal display.

It needs note that, in this article, the relational terms such as first and second is only used to distinguish one entity or operating another entity or an operation, it is not necessary to require or imply that there exists any such relationship or sequence between the entity and operation. Besides, the terms “comprise,” “include,” or any other variation are intended to cover a non-exclusive inclusion, thereby making that comprising a series of process, method, materials or apparatus of element not only comprise those elements, but also comprise other elements not expressly listed, or also comprise such inherent elements of process, method, materials or apparatus. In the absence of more restrictive conditions, limiting the elements by the statement “comprises a . . .”, it doesn't exclude that it also exists other identical elements in comprising the process, method, materials or apparatus of element.

The above description is only the specific embodiment in the present invention, be noted that, for those ordinary technical personnel in this art, it also can be improved and modified under the circumstance of without disobeying the present application principle, these improvements and modifications are also considered in the scope of the present application.

What is claimed is:

1. A white tracking adjustment method, which is used to adjust the color shift of a liquid crystal display, wherein, it comprises: dividing a display panel of a liquid crystal display into a plurality of regions according to the difference of the distance of the trace kept away from a source driving IC;
respectively adjusting the white tracking of the plurality regions referring to the different white tracking reference tables.

2. The white tracking adjustment method as claimed in claim 1, wherein, in view of the region which the trace is far from the source driving IC, through changing the white tracking code in the white tracking reference table to adjust the white tracking, in order to offset the color shift resulted from the data signal delay caused by the difference of the trace distance.

3. The white tracking adjustment method as claimed in claim 1, wherein, for each part of the source driving IC connected to the liquid crystal display panel, dividing the liquid display panel of this part into 3-7 regions.

4. The white tracking adjustment method as claimed in claim 2, wherein, for each part of the source driving IC connected to the liquid crystal display panel, dividing the liquid display panel of this part into 3-7 regions.

5. The white tracking adjustment method as claimed in claim 3, wherein, for each part of the source driving IC connected to the liquid crystal display panel, dividing the liquid display panel of this part into 3 regions.

6. The white tracking adjustment method as claimed in claim 4, wherein, for each part of the source driving IC connected to the liquid crystal display panel, dividing the liquid display panel of this part into 3 regions.

7. A manufacturing method of liquid crystal display, wherein, it comprises:
assembling a liquid crystal display panel;
adjusting the white tracking of the liquid crystal display panel; wherein, the steps of the white tracking adjustment comprises:
dividing a display panel of a liquid crystal display into a plurality of regions according to the difference of the distance of the trace kept away from a source driving IC;
respectively adjusting the white tracking of the plurality regions referring to the different white tracking reference tables.

8. The manufacturing method of liquid crystal display as claimed in claim 7, wherein, in view of the region which the trace is far from the source driving IC, through changing the white tracking code in the white tracking reference table to adjust the white tracking, in order to offset the color shift resulted from the data signal delay caused by the difference of the trace distance.

9. The manufacturing method of liquid crystal display as claimed in claim 7, wherein, for each part of the source driving IC connected to the liquid crystal display panel, dividing the liquid display panel of this part into 3-7 regions.

10. The manufacturing method of liquid crystal display as claimed in claim 8, wherein, for each part of the source driving IC connected to the liquid crystal display panel, dividing the liquid display panel of this part into 3-7 regions.

11. The manufacturing method of liquid crystal display as claimed in claim 9, wherein, for each part of the source driving IC connected to the liquid crystal display panel, dividing the liquid display panel of this part into 3 regions.

12. The manufacturing method of liquid crystal display as claimed in claim 10, wherein, for each part of the source driving IC connected to the liquid crystal display panel, dividing the liquid display panel of this part into 3 regions.

13. A liquid crystal display, which comprises a liquid crystal display panel, wherein, the liquid crystal display panel adjusts the color shift through the white tracking adjustment method, the white balance adjustment method comprises:
dividing a display panel of a liquid crystal display into a plurality of regions according to the difference of the distance of the trace kept away from a source driving IC;
respectively adjusting the white tracking of the plurality regions referring to the different white tracking reference tables.

14. The liquid crystal display as claimed in claim 13, wherein, in view of the region which the trace is far from the source driving IC, through changing the white tracking code in the white tracking reference table to adjust the white tracking, in order to offset the color shift resulted from the data signal delay caused by the difference of the trace distance.

15. The liquid crystal display as claimed in claim 13, wherein, for each part of the source driving IC connected to the liquid crystal display panel, dividing the liquid display panel of this part into 3-7 regions.

16. The liquid crystal display as claimed in claim 14, wherein, for each part of the source driving IC connected to the liquid crystal display panel, dividing the liquid display panel of this part into 3-7 regions.

17. The liquid crystal display as claimed in claim 15, wherein, for each part of the source driving IC connected to the liquid crystal display panel, dividing the liquid display panel of this part into 3 regions.

18. The liquid crystal display as claimed in claim 16, wherein, for each part of the source driving IC connected to the liquid crystal display panel, dividing the liquid display panel of this part into 3 regions.
